(19) United States
(12) Patent Application Publication
(10) Pub. No.: US 2008/0276276 A1
(43) Pub. Date: Nov. 6, 2008

(54) APPARATUS AND METHOD OF RECEIVING ELECTRONIC PROGRAM GUIDE

(75) Inventors: Myong-kyun Lim, Seoul (KR); Yong-ku Kim, Suwon-si (KR); Hyo-sun Shim, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/018,946

(22) Filed: Jan. 24, 2008

(30) Foreign Application Priority Data
May 1, 2007 (KR) 2007-42264

(51) Int. Cl. H04N 5/445; G06F 3/00; H04N 7/173

(52) U.S. Cl. 725/39; 725/91; 725/114

(57) ABSTRACT

An apparatus for and a method of receiving an electronic program guide (EPG), the EPG receiving apparatus including: a receiving unit to receive basic EPG information and detailed EPG information corresponding to the basic EPG information from the server; a buffer to temporarily store the detailed EPG information; a control unit to request the detailed EPG information corresponding to the basic EPG information that is currently displayed on a screen, to receive the detailed EPG information from the server, and to store the detailed EPG information in the buffer; and a display unit to display selected detailed EPG information from among the detailed EPG information stored in the buffer and the basic EPG information. Accordingly, the detailed EPG information is provided to users within a short time period.

### CROSS-REFERENCE TO RELATED APPLICATION

This application claims the benefit of Korean Application No. 2007-42264, filed May 1, 2007 in the Korean Intellectual Property Office, the disclosure of which is incorporated herein by reference.

### BACKGROUND OF THE INVENTION

1. Field of the Invention

Aspects of the present invention relate to an apparatus and method of receiving an electronic program guide (EPG).

2. Description of the Related Art

Broadcasting receivers generally provide broadcasting programs through a plurality of channels. Accordingly, a service that allows broadcasting viewers to easily select desired broadcasting programs from the plurality of channels has been proposed. Such a service is known as an EPG service. The EPG service transmits EPG information, which is guide information for broadcasting programs that a broadcasting receiver can receive. Accordingly, the EPG service helps users living in a multi-channel age to easily select a channel from among a plurality of channels.

FIG. 1 illustrates a transmission of EPG data between a broadcasting receiver and a broadcasting station server. The broadcasting receiver (such as a digital TV or an Internet Protocol television (IPTV)) receives audio data and video data from the broadcasting station server according to a standard (such as MPEG2-TS). The broadcasting receiver also receives EPG information or an EPG stream. MPEG2-TS is a standard for transmitting or storing an MPEG video bitstream, an MPEG audio bitstream, and system information (SI) data in a bundle, and provides a unit for synchronizing a video signal with an audio signal.

Examples of the EPG information received by the broadcasting receiver include basic EPG information and detailed EPG information. The basic EPG information is obtained by briefly tabling only program titles, channels, and broadcasting hours. In contrast, detailed EPG information includes descriptions of programs. General broadcasting receivers are set to receive both basic EPG information and detailed EPG information from broadcasting station servers, to store the received EPG information, and to rapidly provide the stored EPG information to users according to selections of the users.

However, when a network for receiving EPG information from a broadcasting station server is bad, it may be difficult for users to rapidly receive desired detailed EPG information. In addition, movable reception terminals having limited storage capacities may have storage limits that prevent the storing of the entire detailed EPG information.

### SUMMARY OF THE INVENTION

Aspects of the present invention provide an apparatus and method of receiving an electronic program guide (EPG), such that EPG information is provided to users within a short time period.

Aspects of the present invention also provide an apparatus and method of receiving an EPG, such that only necessary EPG information is stored using a small storage capacity.

According to an aspect of the present invention, there is provided an electronic program guide (EPG) receiving apparatus to perform bi-directional communications with a server that provides EPG information, the EPG receiving apparatus including: a receiving unit to receive basic EPG information and detailed EPG information of one or more broadcasting programs corresponding to basic EPG information that is currently displayed on a screen from the server; a buffer to temporarily store the detailed EPG information; a control unit to request the detailed EPG information corresponding to the currently displayed basic EPG information from the server, to receive the detailed EPG information from the server, and to store the received detailed EPG information in the buffer; and a display unit to display, on the screen, the basic EPG information and selected detailed EPG information from among the detailed EPG information stored in the buffer.

The control unit may include a requesting unit to request the server for new detailed EPG information of broadcasting programs included in new basic EPG information that is displayed by the display unit when the basic EPG information displayed by the display unit is renewed.

The requesting unit may automatically request the server for the new detailed EPG information of the broadcasting programs included in the new basic EPG information when the basic EPG information displayed by the display unit is renewed only when the requesting unit is in a detailed EPG automatic requesting mode.

The buffer may delete the detailed EPG information of broadcasting programs not included in the new basic EPG information.

The control unit may further include a sequence determination unit to determine a sequence in which the new detailed EPG information is received, and the requesting unit may request the server for the new detailed EPG information according to the sequence determined by the sequence determination unit.

The control unit may further include a network determination unit to determine a status of a network between the EPG receiving apparatus and the server, such that, according to the status of the network, the requesting unit may further request video on demand (VOD) information and/or user-created contents (UCC) information that are associated with broadcasting programs included in the new basic EPG information.

The receiving unit may further receive the requested VOD information and/or the requested UCC information from the server, and the buffer may temporarily store the received VOD information and/or the received UCC information, such that the display unit may display the VOD information and/or the UCC information stored in the buffer at the request of the user.

The network determination unit may determine the status of the network between the EPG receiving apparatus and the server by determining a packet transmission speed.

The network determination unit may determine the packet transmission speed by transmitting a test packet to the server and measuring a time taken for the transmitted test packet to return.

When the detailed EPG information has been received from the server, the display unit may indicate on a broadcasting program entry in the currently displayed basic EPG information that detailed EPG information corresponding to the broadcasting program entry is stored in the buffer when the receiving unit receives the detailed EPG information corresponding to the broadcasting program entry.

The display unit may indicate on the broadcasting program entry in the currently displayed basic EPG information that the detailed EPG information corresponding to the broadcasting program entry is stored in the buffer by changing a color of the broadcasting program entry from a first color, indicating that the detailed EPG information corresponding to the broadcasting program entry is not stored in the buffer, to a second color, indicating that the detailed EPG information corresponding to the broadcasting program entry is stored in buffer.

When the VOD information and/or the UCC information has been received from the server, the display unit may indicate on the screen that the VOD information and/or the UCC information is stored in the buffer when the receiving unit receives the VOD information and/or the UCC information.

According to another aspect of the present invention, there is provided an EPG receiving apparatus performing bi-directional communications with a server that provides EPG information, the EPG receiving apparatus including: a receiving unit to receive, from the server, basic EPG information and detailed EPG information of one or more broadcasting programs corresponding to a location of a cursor on basic EPG information that is currently displayed on a screen; a buffer to temporarily store the received detailed EPG information; a control unit to request the detailed EPG information corresponding to the location of the cursor on the currently displayed basic EPG information, to receive the requested detailed EPG information from the server, and to store the received detailed EPG information in the buffer; and a display unit to display, on the screen, the received basic EPG information and selected detailed EPG information from among the detailed EPG information stored in the buffer.

The control unit may include a requesting unit to request new detailed EPG information of one or more broadcasting programs when the cursor moves from a first location to a second location, different from the first location, on the currently displayed basic EPG information, the new detailed EPG information corresponding to the second location of the cursor.

When the cursor moves from the first location to the second location, the buffer may delete the detailed EPG information corresponding to the first location of the cursor.

The buffer may delete the stored detailed EPG information if the stored detailed EPG information is not selected to be displayed within a predetermined period of time.

The display unit may indicate on a broadcasting program entry in the currently displayed basic EPG information that detailed EPG information corresponding to the broadcasting program entry is stored in the buffer when the receiving unit receives the detailed EPG information corresponding to the broadcasting program entry.

The display unit may indicate the receipt of the detailed EPG information by changing the color of an entry of the program corresponding to the received detailed EPG information.

According to another aspect of the present invention, there is provided an EPG receiving method of performing bi-directional communications with a server that provides EPG information, the EPG receiving method including: receiving and displaying basic EPG information from the server; receiving detailed EPG information of one or more broadcasting programs corresponding to the currently displayed basic EPG information from the server; temporarily storing the detailed EPG information; and displaying selected detailed EPG information from among the stored detailed EPG information.

The method may further include: renewing the displayed basic EPG information such that new basic EPG information is displayed; requesting new detailed EPG information of broadcasting programs included in the new basic EPG information; and receiving the requested new detailed EPG information.

The requesting of the new detailed EPG information may include automatically requesting the new detailed EPG information of the broadcasting programs included in the new basic EPG information when the displayed basic EPG information is renewed only when a detailed EPG automatic requesting mode is set.

The method may further include deleting detailed EPG information of broadcasting programs not included in the new basic EPG information.

The requesting to the server may include: determining a sequence in which the new detailed EPG information is received; and requesting the new detailed EPG information from the server according to the determined sequence.

The requesting of the new detailed EPG information may include: determining a status of a network connecting to the server; and according to the status of the network, requesting VOD information and/or UCC information that are associated with the broadcasting programs included in the new basic EPG information.

The method may further include: receiving the requested VOD information and/or the requested UCC information from the server; temporarily storing the received VOD information and/or the received UCC information; and displaying the stored VOD information and/or the stored UCC information at a request of the user.

The status of the network may be determined by determining a packet transmission speed.

The packet transmission speed may be determined by transmitting a test packet to the server and measuring a time taken for the transmitted test packet to return.

When the detailed EPG information has been received from the server, the receipt of the detailed EPG information may be indicated on a broadcasting program entry of the basic corresponding to the received detailed EPG information in the basic EPG information.

The receipt of the detailed EPG information may be indicated by changing the color of the broadcasting program entry corresponding to the received detailed EPG information on the basic EPG information.

The method may further include display an indication that the VOD information and/or the UCC information has been received from the server.

According to another aspect of the present invention, there is provided an EPG receiving method capable of performing bi-directional communications with a server that provides EPG information, the method including: receiving basic EPG information from the server; receiving, from the server, detailed EPG information of one or more broadcasting programs corresponding to a location of the cursor on basic EPG information that is currently displayed on a screen; temporarily storing the received detailed EPG information; and displaying, on the screen, selected detailed EPG information from among the stored detailed EPG information.

The method may further include: as the cursor is moved, requesting the server for new detailed EPG information about a program on new basic EPG information at which the cursor locates; and receiving the requested detailed EPG information.

The method may further include, as the cursor on the currently displayed basic EPG information screen moves, deleting the detailed EPG information corresponding to the basic EPG information at which the cursor was located before moving.

The method may further include, when a request from a user for the stored detailed EPG information is not made within a predetermined period of time, the detailed EPG information may be deleted.

The method may further include: indicating on a broadcasting program entry in the currently displayed basic EPG information that detailed EPG information corresponding to the broadcasting program entry is stored when the detailed EPG information corresponding to the broadcasting program entry is received.

The indicating on the broadcasting entry may include: changing a color of the broadcasting program entry from a first color, indicating that the detailed EPG information corresponding to the broadcasting program entry is not stored, to a second color, indicating that the detailed EPG information corresponding to the broadcasting program entry is stored.

According to another aspect of the present invention, there is provided a computer readable recording medium having recorded thereon a program for an EPG receiving method performing bi-directional communications with a server that provides EPG information, the method including: receiving and displaying basic EPG information from the server; receiving detailed EPG information of one or more broadcasting programs corresponding to currently displayed basic EPG information from the server; temporarily storing the received detailed EPG information; and displaying selected detailed EPG information from among the stored detailed EPG information.

According to yet another aspect of the present invention, there is provided a computer readable recording medium having recorded thereon a program for an EPG receiving method performing bi-directional communications with a server that provides EPG information, the EPG receiving method including: receiving basic EPG information from the server; receiving, from the server, detailed EPG information of one or more broadcasting programs corresponding to a location of a cursor on basic EPG information that is currently displayed on a screen; temporarily storing the received detailed EPG information; and displaying, on the screen, selected detailed EPG information from among the stored detailed EPG information.

According to still another aspect of the present invention, there is provided an EPG receiving apparatus to perform bi-directional communications with a server that provides EPG information, the EPG receiving apparatus including: a receiving unit to receive basic EPG information on a first number of broadcasting programs, and to receive detailed EPG information on a second number of broadcasting programs from among the first number of broadcasting programs, the first number greater than the second number; and a buffer to temporarily store the received detailed EPG information.

The apparatus may further include: a display unit to display only basic EPG information on the second number of broadcasting programs from among the received basic EPG information; and a control unit to control the receiving unit to receive the detailed EPG information on the second number of broadcasting programs corresponding to the displayed basic EPG information.

The apparatus may further include: a display unit to display the received basic EPG information; and a control unit to control the receiving unit to receive the detailed EPG information on the second number of broadcasting programs according to a location of a cursor on the display unit, wherein the cursor is located on one or more broadcasting program entries corresponding to the second number of broadcasting programs.

According to another aspect of the present invention, there is provided an EPG receiving method of performing bi-directional communications with a server that provides EPG information, the method including: receiving basic EPG information on a first number of broadcasting programs; receiving detailed EPG information on a second number of broadcasting programs from among the first number of broadcasting programs, the first number greater than the second number; and temporarily storing the received detailed EPG information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a transmission of electronic program guide (EPG) data between a broadcasting receiver and a broadcasting station server;

FIG. 2 is a block diagram of an EPG receiving apparatus according to an embodiment of the present invention;

FIG. 3 is a reference diagram illustrating a basic EPG information screen according to an embodiment of the present invention;

FIG. 4 is a reference diagram illustrating a detailed EPG information screen according to an embodiment of the present invention;

FIG. 5 is a detailed block diagram of an EPG receiving apparatus according to an embodiment of the present invention;

FIG. 6 illustrates a video on demand (VOD) information screen according to an embodiment of the present invention;

FIG. 7 illustrates a user-created contents (UCC) information screen according to an embodiment of the present invention;

FIG. 8 is a block diagram of an EPG receiving apparatus according to another embodiment of the present invention;

FIG. 9 illustrates a screen on which both basic EPG information and detailed EPG information are displayed according to another embodiment of the present invention;

FIG. 10 illustrates two screens on which basic EPG information and detailed EPG information are displayed separately according to another embodiment of the present invention;

FIG. 11 is a flowchart of an EPG receiving method according to an embodiment of the present invention; and

FIG. 12 is a flowchart of an EPG receiving method according to another embodiment of the present invention.

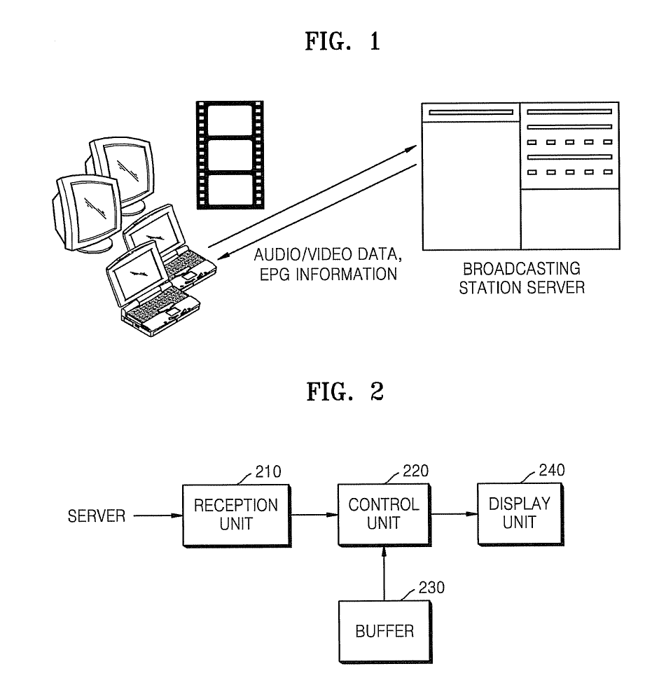

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a block diagram of an Electronic Program Guide (EPG) receiving apparatus according to an embodiment of the present invention. Referring to FIG. 2, the EPG receiving apparatus includes a reception unit 210, a control unit 220, a buffer 230, and a display unit 240.

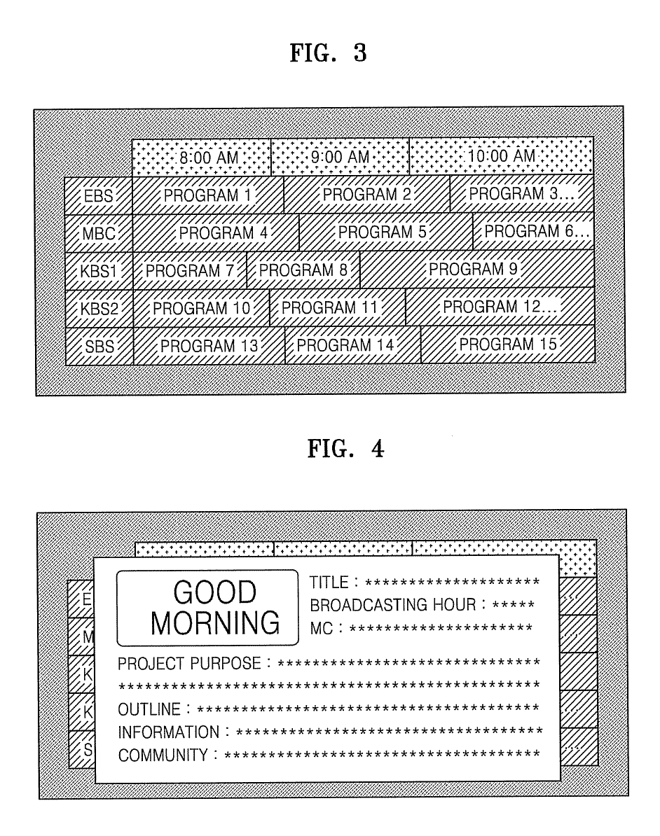

The reception unit 210 receives basic EPG information and detailed EPG information from a server. The basic EPG information includes titles of broadcasting programs transmitted via broadcasting channels and broadcasting hours of the broadcasting programs, as shown in FIG. 3. The detailed EPG information provides detailed descriptions of broadcasting programs (such as the titles, contents, outlines, etc. of the programs), as shown in FIG. 4. The basic EPG information and the detailed EPG information are received in order to facilitate a user's program selections. In other words, the reception unit 210 receives such basic EPG information and such detailed EPG information from a broadcasting station server that provides EPG information.

The control unit 220 performs control operations to request the detailed EPG information according to currently displayed basic EPG information from the server, to receive the requested detailed EPG information from the server, and to store the received detailed EPG information in the buffer 230. For example, when the currently displayed basic EPG information is as illustrated in FIG. 3, the control unit 220 requests, from the server, detailed EPG information about the broadcasting programs displayed on the screen of FIG. 3. The server transmits the requested detailed EPG information to the EPG receiving apparatus, and the received EPG information is temporarily stored in the buffer 230.

When the basic EPG information currently being displayed on a screen is renewed or refreshed (i.e., when new broadcasting programs other than the broadcasting programs displayed on a basic EPG information screen appear on a new screen), detailed EPG information about the new broadcasting programs is stored in the buffer 230, and detailed EPG information about broadcasting programs not shown on the new screen is deleted from the buffer 230. In other words, the control unit 220 compares a list of broadcasting programs displayed on a current screen with a list of broadcasting programs corresponding to the detailed EPG information stored in the buffer 230, requests detailed EPG information about broadcasting programs newly displayed on the current screen from the server, stores the requested detailed EPG information in the buffer 230, and deletes detailed EPG information about broadcasting programs not displayed on the current screen from the buffer 230.

According to an aspect of the present invention, when the received detailed EPG information is stored in the buffer 230, display colors of broadcasting programs corresponding to the received detailed EPG information on the basic EPG information screen may be changed so as to inform the user that the detailed EPG information available.

The display unit 240 provides the basic EPG information screen to the user. When the user selects a desired program on the basic EPG information screen, the display unit 240 displays detailed EPG information of the selected program. For example, when the user selects a broadcasting program entitled “Good Morning” on the screen shown in FIG. 3, detailed EPG information of the program “Good Morning” is displayed as illustrated in FIG. 4. The user may select the broadcasting program by using a mouse, a remote control, a touch screen on the display unit, or via other methods and/or devices. The detailed EPG information illustrated in FIG. 4 includes a logo, a title, a broadcasting hour, a master of ceremonies (MC), a project purpose, etc., of the program “Good Morning.” However, it is understood that the detailed EPG information does not necessarily include the abovementioned information, and/or may include additional or other information (such as cast and program summary).

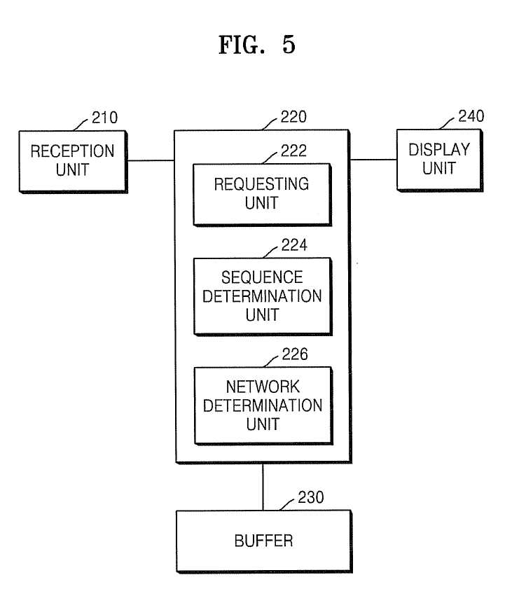

FIG. 5 is a detailed block diagram of an EPG receiving apparatus according to an embodiment of the present invention. Referring to FIG. 5, the EPG receiving apparatus includes the reception unit 210, the control unit 220, the buffer 230, and the display unit 240. Furthermore, the control unit 220 includes a requesting unit 222, an arranging unit 224, and a network determination unit 226.

As the basic EPG information screen currently displayed on the display unit 240 is renewed (i.e., refreshed), the requesting unit 222 requests the server for new detailed EPG information corresponding to new broadcasting programs displayed on a new basic EPG information screen. When the requesting unit 222 is set to an automatic requesting mode, the requesting unit 222 automatically requests the new detailed EPG information when the basic EPG information screen is renewed. The user may set the automatic requesting mode, or the automatic requesting mode may be a default setting. On the other hand, when the requesting unit 222 is not set to the automatic requesting mode, the requesting unit 222 requests the new detailed EPG information from the server only when the user manually requests the detailed EPG information.

The sequence determination unit 224 determines a sequence in which detailed EPG information about the new broadcasting programs included in the new basic EPG information screen is received. When the basic EPG information screen is renewed, detailed EPG information about new broadcasting programs is requested from the server. The sequence of requests and receptions of the detailed EPG information for the new broadcasting programs is determined by the sequence determination unit 224. The priority of the broadcasting programs (i.e., the priority of receiving the detailed EPG information for the broadcasting programs) may be set according to any one or more of a user selection, a currently broadcasted program, a genre or broadcasting program designated by the user, a broadcasting time, etc.

The network determination unit 226 determines a state of a network between the EPG receiving apparatus and the server. When the network determination unit 226 determines that the network state is at or above a predetermined level (i.e., the state of the network is good), the requesting unit 222 requests the detailed EPG information of the broadcasting programs included in the basic EPG information as well as video on demand (VOD) information and/or user-created contents (UCC) information from the server. Then, the EPG receiving apparatus receives the requested information via the reception unit 210.

The network determination unit 226 may determine the network state with the server by ascertaining a packet transmission speed. The packet transmission speed may be ascertained by measuring a time during which a test packet transmitted to the server returns. For example, a test packet that records a current local time is transmitted to the server (i.e., an EPG information provider), and the server returns the received packet to the EPG receiving apparatus, which is a client. In other words, the network state is determined by measuring the time period during which the transmitted test packet returns to the EPG receiving apparatus. When the time period during which the transmitted test packet returns is less than or equal to a predetermined value, the network determination unit 226 determines that the network is in a good state. Accordingly, the requesting unit 222 may request not only the detailed EPG information, but also the VOD information and/or the UCC information from the server.

VOD is a bi-directional image providing service that allows subscribers to immediately select and watch desired broadcasting programs at desired hours, as opposed to a conventional pay per view (PPV) service that makes subscribers wait for a set broadcasting time of a desired program. Examples of VOD information associated with broadcasting programs may include information on a regular (i.e., non-VOD) broadcasting program that broadcasts at a different time from a current time, or about broadcasting programs related to the VOD broadcasting program.

UCC refers to contents that are created by a user without commercial intentions and released through an on-line computer network. Examples of UCC information may include a list of contents that users upload in relation to the broadcasting programs displayed on the basic EPG information screen.

When the network state is good, the requesting unit 222 requests the server for the VOD and/or the UCC information of a broadcasting program. When the receiving unit 210 receives the requested VOD and/or UCC information from the server, the received VOD and/or UCC information is stored in the buffer 230. When the VOD and/or UCC information is stored in the buffer 230, a button or icon informing that the VOD and/or UCC information is ready to be displayed may be output on the basic EPG information screen. It is understood that other methods may be used to inform the user that the VOD and/or UCC information is available (such as a sound or an added menu option). For example, a mark V and/or U may appear next to a program title on the basic EPG information screen so that a user can recognize that the VOD and/or UCC information has been stored. When the user selects the mark V or U displayed on the screen, the VOD or UCC information corresponding to the selected mark V or U is displayed on the screen. The user may select the mark V or U via a remote controller, a mouse, or a touch screen on the display unit 240.

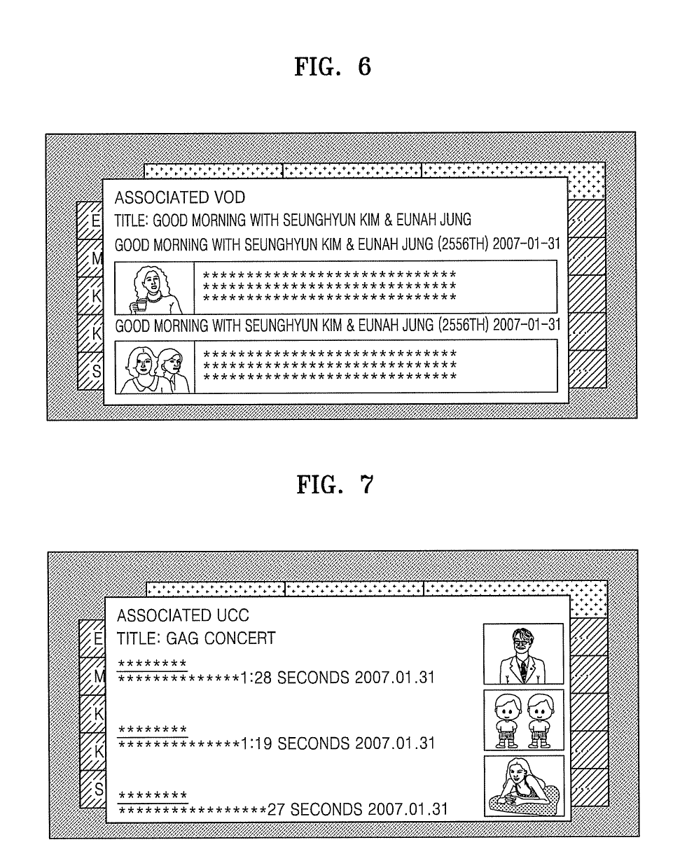

FIG. 6 illustrates a VOD information screen according to an embodiment of the present invention. When a user selects for example, a mark VOD displayed on a screen, a list of selectable VODs and information about the VODs are displayed as illustrated in FIG. 6. The user can select a desired VOD from the VOD list and watch the desired VOD.

FIG. 7 illustrates a UCC information screen according to an embodiment of the present invention. When a user selects, for example, a mark UCC displayed on a screen, a list of selectable UCCs and information about the UCCs are displayed as illustrated in FIG. 7. The user can select a desired UCC from the UCC list and watch the desired UCC.

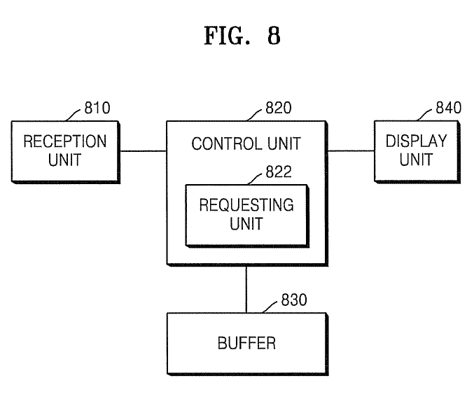

FIG. 8 is a block diagram of an EPG receiving apparatus according to another embodiment of the present invention. Referring to FIG. 8, the EPG receiving apparatus includes a receiving unit 810, a control unit 820, a buffer 830, and a display unit 840. Furthermore, the control unit 820 includes a requesting unit 822.

The receiving unit 810 receives basic EPG information and detailed EPG information from a server. The basic EPG information includes titles of broadcasting programs transmitted via broadcasting channels and broadcasting hours of the broadcasting programs, as shown in FIG. 3. The detailed EPG information provides detailed descriptions of broadcasting programs (such as the titles, contents, outlines, etc., of the programs) as shown in FIG. 4. The basic EPG information and the detailed EPG information are received in order to help users select desired broadcasting programs. In other words, the reception unit 810 receives such basic EPG information and such detailed EPG information from a broadcasting station server that provides EPG information (for example, from a service discovery & selection (SD&S) server).

The control unit 820 controls the requesting unit 822 to request detailed EPG information from the broadcasting station server, receives the requested detailed EPG information, and stores the received detailed EPG information in the buffer 830. According to an aspect of the present invention, the control unit 820 may control the requesting unit 822 to request the detailed EPG information of a broadcasting program when a cursor (or other user-controlled selection device or unit) is located in a predetermined location in relation to basic EPG information of the broadcasting program in a basic EPG information screen. For example, if the cursor is located above the basic EPG information of the broadcasting program, or above basic EPG information of a neighboring broadcasting program, the control unit 820 may control the requesting unit to request the detailed EPG information of the broadcasting program.

According to another aspect, as the cursor moves on a basic EPG information screen currently being displayed on the display unit 840, the requesting unit 822 requests detailed EPG information corresponding to the broadcasting programs appearing on the basic EPG information screen from the server. In other words, before a direct request from a user (for example, when the user clicks a mouse), when the cursor is at a standstill at a designated location for a predetermined period of time or at the moment the cursor moves to the designated location, detailed EPG information is requested. A mouse clicking performed by the user is recognized as a request to display the detailed EPG information. Thus, the time between the mouse click and the receipt of the detailed EPG information upon request to the server can be minimized. It is understood that other selection devices aside from a mouse and a cursor (such as a touch screen or a rotatable dial) may be used to select a broadcasting program for which detailed EPG information is received and/or displayed.

Alternatively, a user can set the detailed EPG information automatic-requesting mode (or, the automatic-requesting mode may be the default mode of the EPG receiving apparatus). When the requesting unit 822 is set in the detailed EPG information automatic-requesting mode, the requesting unit 822 automatically requests new detailed EPG information according to a renewal of the basic EPG information screen (as described above with reference to FIG. 5. When the requesting unit 822 is not set in the detailed EPG information automatic-requesting mode, the requesting unit 822 may only request detailed EPG information from the server, for example, when the user clicks the mouse. The buffer 830 stores the received detailed EPG information and deletes previously stored detailed EPG information.

When the received detailed EPG information is stored in the buffer 830, the display color of the broadcasting program corresponding to the received detailed EPG information is changed so as to inform the user that the detailed EPG information is ready to be displayed. However, it is understood that aspects of the present invention are not limited thereto.

The display unit 840 provides the basic EPG information screen. When the user selects a desired broadcasting program from the basic EPG information screen, the display unit 840 displays detailed EPG information about the selected broadcasting program. Because the detailed EPG information has been stored in the buffer 830 according to, for example, the motion of the cursor or the renewing of the basic EPG information screen before the selection of the user, the detailed EPG information can be displayed to the user via the display unit 840 simultaneously with (or shortly after) the selection of the user. In addition, even when no user's selections are made, the detailed EPG information for a broadcasting program over which the cursor is located may be displayed with the basic EPG information on the same screen.

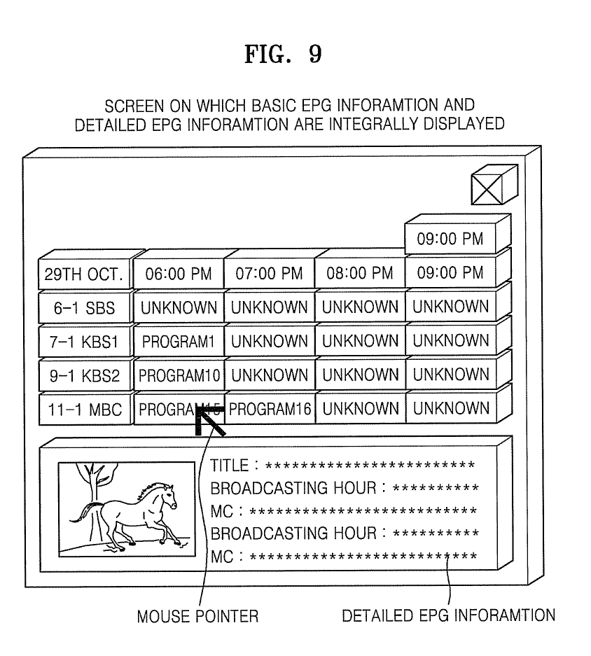

FIG. 9 illustrates a single screen on which both a basic EPG information block and a detailed EPG information block are integrally displayed according to another embodiment of the present invention. Referring to FIG. 9, when a basic EPG information screen is displayed to a user, the user moves a cursor to a specific broadcasting program by using a mouse on the basic EPG screen. In response to the cursor motion by the user, the requesting unit 822 requests detailed EPG information about the specific program from the server, and receives the detailed EPG information via the receiving unit 810. The received detailed EPG information is stored in the buffer 830, and displayed on the basic EPG information screen upon an input of the user, such as mouse click or screen touch. FIG. 9 illustrates a case where both detailed EPG information about a broadcasting program selected by a user and basic EPG information are displayed on a single screen. It is understood that selection devices other than the cursor and the mouse may be used.

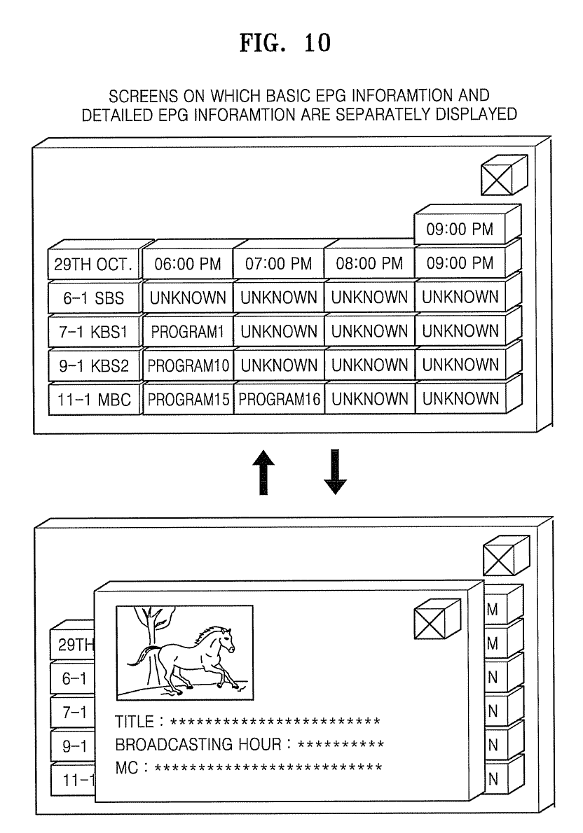

FIG. 10 illustrates two screens on which basic EPG information and detailed EPG information are displayed separately according to another embodiment of the present invention. Referring to FIG. 10, when a user performs an input operation, such as a mouse click, on a specific broadcasting program on a basic EPG information screen, a detailed EPG information screen is displayed. In contrast to FIG. 9, the detailed EPG information is displayed on a screen different from the basic EPG information screen.

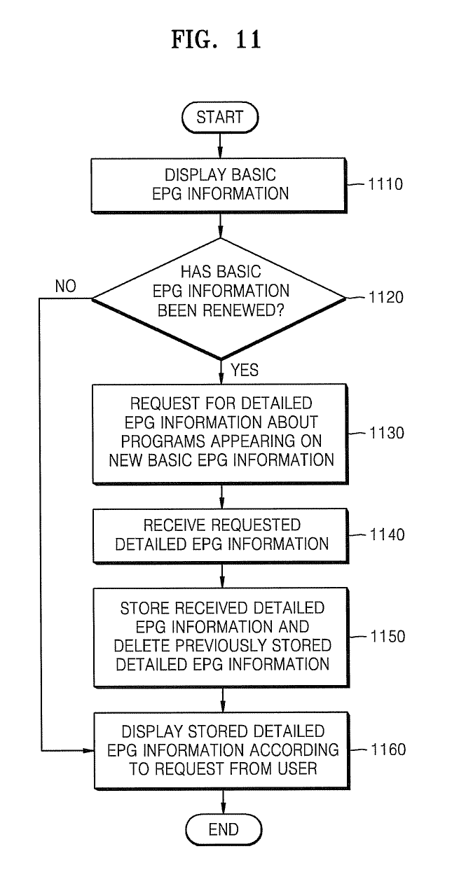

FIG. 11 is a flowchart of an EPG receiving method according to an embodiment of the present invention. Referring to FIG. 11, a basic EPG information screen is displayed to a user in operation 1110. The basic EPG information screen is a screen on which only simple broadcasting information (i.e., basic EPG information), such as broadcasting hours, channels, and program titles, are displayed (for example, the screen illustrated in FIG. 3).

It is determined whether the basic EPG information screen has been renewed (i.e., referreshed) in operation 1120. The screen renewal refers to a change of the basic EPG information screen currently being displayed. For example, the screen renewal is performed when a new basic EPG information screen for broadcasting programs not displayed on the previous basic EPG information screen is displayed by the movement of the previous screen by a user using a remote controller or a mouse.

If the screen is renewed (operation 1120), a request is made to the broadcasting station server for detailed EPG information about the broadcasting programs appearing on the new basic EPG information screen in operation 1130. Only the detailed EPG information about broadcasting programs newly displayed on the new screen is requested. Thus, detailed EPG information for broadcasting programs included in both the new basic EPG information screen and the previous basic EPG information screen is not requested from the server because such EPG information has already been stored in a buffer. When a network state is good, VOD and/or UCC information may also be requested together with the detailed EPG information.

Next, the requested detailed EPG information is received in operation 1140. When the VOD and/or UCC information is also requested, the VOD and/or UCC information may also be received together with the requested detailed EPG information.

The received detailed EPG information is stored in the buffer and detailed EPG information already stored in the buffer but not corresponding to any broadcasting programs in the new basic EPG information screen is deleted in operation 1150.

Detailed EPG information stored in the buffer is displayed according to a request from the user in operation 1160. The request from the user may be made by a mouse click, a remote control click, or a screen touch, although not limited thereto. The detailed EPG information stored in the buffer may be displayed on a screen simultaneously with the request from the user.

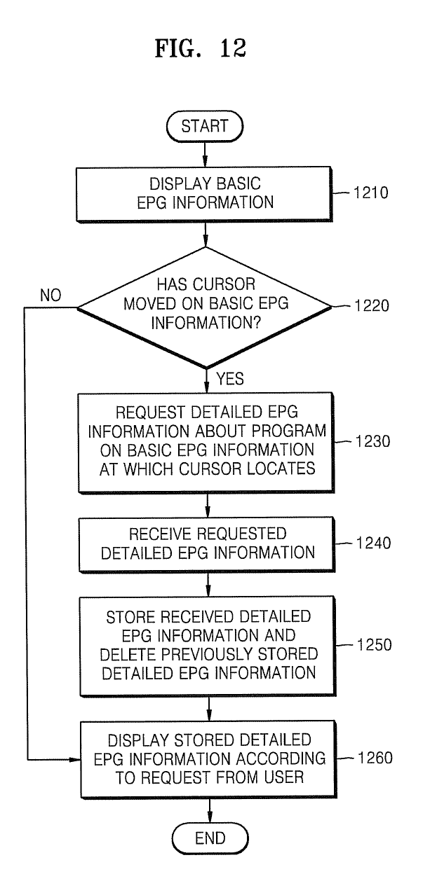

FIG. 12 is a flowchart of an EPG receiving method according to another embodiment of the present invention. Referring to FIGS. 8 and 12, a basic EPG information screen is displayed on the display unit 840 in operation 1210. The basic EPG information screen is a screen on which only simple broadcasting information (i.e., basic EPG information), such as broadcasting hours, channels, and program titles, are displayed (for example, the screen illustrated in FIG. 3).

It is determined whether a cursor (or other selection device, unit, or graphic) has moved on the basic EPG information screen or whether the cursor has been at a standstill for a predetermined period of time after moving in operation 1220. Accordingly, when the cursor has moved to a specific program title displayed on the basic EPG information screen and has been at a standstill for the predetermined period of time before a mouse clicking operation of the user, the detailed EPG information is received in advance. Thus, a detailed EPG information screen is provided to the user simultaneously with the mouse clicking operation of the user. It is understood that selection devices other than a mouse and/or selection methods other than a clicking operation may be used according to aspects of the present invention.

Then, detailed EPG information about a broadcasting program on the basic EPG information screen on which the cursor is located is requested from a broadcasting station server. The request for the detailed EPG information of the corresponding broadcasting program may be made simultaneously with the movement of the cursor or after the cursor has been at a standstill on the corresponding broadcasting program for the predetermined period of time.

The requested detailed EPG information is received in operation 1240. Then, the received detailed EPG information is stored in the buffer and detailed EPG information already stored in the buffer corresponding to a broadcasting program on which the cursor was located before moving is deleted in operation 1250.

The stored detailed EPG information is displayed at the request of the user. The request of the user may be made by a mouse clicking operation of the user. The detailed EPG information stored in the buffer may be displayed on the screen simultaneously with the request of the user.

As described above, aspects of the present invention provide an apparatus and method of receiving EPG, by which EPG information is provided to a user within a short time period. In addition, only EPG information that a user is more likely to request is temporarily stored and thus a small storage capacity is required. Moreover, VOD or UCC information associated with broadcasting programs can also be provided to the user together with detailed EPG information.

Aspects of the present invention can also be embodied as computer programs and can be implemented in general-use digital computers that execute the programs using a computer-readable recording medium. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An Electronic Program Guide (EPG) receiving method of performing bi-directional communications with a server that provides EPG information, the method comprising:
receiving and displaying basic EPG information from the server;
receiving detailed EPG information of one or more broadcasting programs corresponding to the currently displayed basic EPG information from the server;
temporarily storing the detailed EPG information; and
displaying selected detailed EPG information from among the stored detailed EPG information.

2. The method as claimed in claim 1, further comprising:
renewing the displayed basic EPG information such that new basic EPG information is displayed;
requesting new detailed EPG information of broadcasting programs included in the new basic EPG information; and
receiving the requested new detailed EPG information.

3. The method as claimed in claim 2, wherein the requesting of the new detailed EPG information comprises:
automatically requesting the new detailed EPG information of the broadcasting programs included in the new basic EPG information when the displayed basic EPG information is renewed only when a detailed EPG automatic requesting mode is set.

4. The receiving method as claimed in claim 2, further comprising:
deleting detailed EPG information of broadcasting programs not included in the new basic EPG information.

5. The method as claimed in claim 2, wherein the requesting of the new detailed EPG information comprises:
determining a sequence in which the new detailed EPG information is received; and
requesting the new detailed EPG information from the server according to the determined sequence.

6. The method as claimed in claim 2, wherein the requesting of the new detailed EPG information further comprises:
determining a status of a network connecting to the server; and
according to the status of the network, requesting video on demand (VOD) information and/or user-created contents (UCC) information that are associated with the broadcasting programs included in the new basic EPG information.

7. The method as claimed in claim 1, further comprising:
determining a status of a network connecting to the server; and
according to the status of the network, requesting video on demand (VOD) information and/or user-created contents (UCC) information that are associated with the broadcasting programs included in the displayed basic EPG information.

8. The method as claimed in claim 6, further comprising:
receiving the requested VOD information and/or the requested UCC information from the server;
temporarily storing the received VOD information and/or the received UCC information; and
displaying the stored VOD information and/or the stored UCC information according to a user request.

9. The method as claimed in claim 7, wherein the determining of the status of the network comprises:
determining a packet transmission speed.

10. The method as claimed in claim 9, wherein the determining of the packet transmission speed comprises:
transmitting a test packet to the server and measuring a time taken for the transmitted test packet to return.

11. The method as claimed in claim 1, further comprising:
indicating on a broadcasting program entry in the currently displayed basic EPG information that detailed EPG information corresponding to the broadcasting program entry is stored when the detailed EPG information corresponding to the broadcasting program entry is received.

12. The method as claimed in claim 11, wherein the indicating on the broadcasting program entry comprises:
changing a color of the broadcasting program entry from a first color, indicating that the detailed EPG information corresponding to the broadcasting program entry is not stored, to a second color, indicating that the detailed EPG information corresponding to the broadcasting program entry is stored.

13. The method as claimed in claim 8, further comprising:
displaying an indication that the VOD information and/or the UCC information is stored when the VOD information and/or the UCC information is received.

14. An Electronic Program Guide (EPG) receiving method of performing bi-directional communications with a server that provides EPG information, the method comprising:
receiving basic EPG information from the server;
receiving, from the server, detailed EPG information of one or more broadcasting programs corresponding to a location of a cursor on basic EPG information that is currently displayed on a screen;
temporarily storing the received detailed EPG information; and
displaying, on the screen, selected detailed EPG information from among the stored detailed EPG information.

15. The method as claimed in claim 14, further comprising:
requesting new detailed EPG information of one or more broadcasting programs when the cursor moves from a first location to a second location, different from the first location, on the currently displayed basic EPG information, the new detailed EPG information corresponding to the second location of the cursor; and
receiving the new detailed EPG information.

16. The method as claimed in claim 15, further comprising:
when the cursor moves from the first location to the second location, deleting the detailed EPG information corresponding to the first location of the cursor.

17. The method as claimed in claim 14, further comprising:
deleting the stored detailed EPG information if the stored detailed EPG information is not selected to be displayed within a predetermined period of time.

18. The method as claimed in claim 14, further comprising:
indicating on a broadcasting program entry in the currently displayed basic EPG information that detailed EPG information corresponding to the broadcasting program entry is stored when the detailed EPG information corresponding to the broadcasting program entry is received.

19. The method as claimed in claim 18, wherein the indicating on the broadcasting program entry comprises:
changing a color of the broadcasting program entry from a first color, indicating that the detailed EPG information corresponding to the broadcasting program entry is not stored, to a second color, indicating that the detailed EPG information corresponding to the broadcasting program entry is stored.

20. The method as claimed in claim 14, further comprising:
requesting video on demand (VOD) information and/or user-created contents (UCC) information corresponding to the received detailed EPG information.

21. The method as claimed in claim 14, further comprising:
determining a status of a network connecting to the server; and
according to the status of the network, requesting video on demand (VOD) information and/or user-created contents (UCC) information corresponding to the received detailed EPG information.

22. A computer readable recording medium encoded with instructions to perform the method of claim 1 and implemented by a computer.

23. A computer readable recording medium encoded with instructions to perform the method of claim 14 and implemented by a computer.

24. An Electronic Program Guide (EPG) receiving method of performing bi-directional communications with a server that provides EPG information, the method comprising:
receiving basic EPG information on a first number of broadcasting programs;
receiving detailed EPG information on a second number of broadcasting programs from among the first number of broadcasting programs, the first number being greater than the second number; and
temporarily storing the received detailed EPG information.

25. The method as claimed in claim 24, further comprising:
displaying only basic EPG information on the second number of broadcasting programs from among the received basic EPG information,
wherein the receiving of the detailed EPG information comprises receiving the detailed EPG information on the second number of broadcasting programs corresponding to the displayed basic EPG information.

26. The method as claimed in claim 24, further comprising:
displaying the received basic EPG information,
wherein the receiving of the detailed EPG information comprises receiving the detailed EPG information on the second number of broadcasting programs according to a location of a cursor on the display unit, wherein the cursor is located on one or more broadcasting program entries corresponding to the second number of broadcasting programs.

27. A computer readable recording medium encoded with instructions to perform the method of claim 24 and implemented by a computer.
